(19) United States
(12) Patent Application Publication
(10) Pub. No.: US 2024/0278787 A1
(43) Pub. Date: Aug. 22, 2024

(54) IN-VEHICLE DEVICE, OPERATION METHOD THEREFOR, AND VEHICLE

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Akihiro OGAWA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/571,743

(22) PCT Filed: Apr. 27, 2022
(86) PCT No.: PCT/JP2022/019001

§ 371 Date: Dec. 19, 2023

(30) Foreign Application Priority Data
Jul. 1, 2021 (JP) 2021-109959

(51) Int. Cl. B60W 40/02; B60W 40/04; B60W 50/00

(52) U.S. Cl. CPC B60W 40/02; B60W 40/04; B60W 50/00; B60W 2556/40; B60W 2556/45

(57) ABSTRACT

This in-vehicle device includes: an in-vehicle server capable of executing one or a plurality of sub-functions forming a subset of a function of an external server, the in-vehicle server being configured to use data received from outside and output subset information capable of replacing a part of the information; a function selection unit configured to select, in response to a fact that reception of the information from the external server has been suspended, at least one of the sub-functions executed by the in-vehicle server, in accordance with a priority based on a traffic environment; a reception determination unit configured to determine that the reception of the information from the external server has been suspended; and a vehicle inside-outside collaboration device configured to provide, in accordance with determination by the reception determination unit that the reception has been suspended, the subset information from the in-vehicle server to the driving support device.

### TECHNICAL FIELD

This disclosure relates to an in-vehicle device, an operation method therefor, and a vehicle. This application claims priority on Japanese Patent Application No. 2021-109959 filed on Jul. 1, 2021, the entire content of which is incorporated herein by reference.

### BACKGROUND ART

A system in which sensor data from a large number of sensors is aggregated in a server and analyzed to be used in driving support is becoming prevalent. The sensor data is transmitted from sensors mounted to vehicles and sensors (hereinafter, referred to as “infrastructure sensor”) in infrastructure equipment provided on roadsides. In such a system, each vehicle connects with a nearby wireless base station by using wireless communication, and performs communication with a server through the wireless base station. It is also possible, through direct communication (so-called vehicle-to-vehicle communication) between vehicles, to transmit sensor data of a certain vehicle to another vehicle, and to transmit information possessed by a certain vehicle to another vehicle.

In the case of a driving support system, delay due to communication poses a problem. For the purpose of reducing delay of wireless communication between a vehicle and a server, a server is installed near the site where a vehicle travels, and sensor data is processed by this server. This server is called an edge server in the sense that the server is installed near the site.

Other than the edge server which analyzes sensor data as above, a large number of so-called cloud servers which provide vehicles with various services through wireless communication are also becoming prevalent. Examples of such services are so-called traffic information distribution, management of a vehicle dispatch schedule for transportation vehicles, etc., distribution of sightseeing and event information in the vicinity of a road, vehicle failure diagnosis, and route guidance. By using the edge servers and the cloud servers, vehicles become able to more safely travel, and in addition, meaningful life can be realized by utilizing vehicles.

Such a system has a premise that vehicles perform communication with the server. Therefore, there is a problem that when a vehicle becomes unable to communicate with the server due to some cause, even if the vehicle has a driving support device, the driving support device becomes useless. If the vehicle can connect with another server, the vehicle may connect with the server. However, in the case of the edge server, the areas managed by other edge servers do not always cover the region where the vehicle is present. Therefore, even if driving support information can be received from those edge servers, there is a high possibility that the driving support information is useless for the vehicle.

In the case of the cloud servers that provide general services, there is a problem that, when there is no substitute server in the vicinity, information of such services cannot be obtained.

PATENT LITERATURE 1 discloses a proposal for solving such a problem. According to the disclosure by PATENT LITERATURE 1, an in-vehicle device is caused to have a function of a mini edge server, which has a function similar to the function of an edge server and being a reduced version thereof. Then, when communication with the edge server has become unable to be performed, the mini edge server is activated. At activation of the mini edge server, the mini edge server is initialized by using data having been received from the edge server to that point, and the output of the mini edge server is used for driving support. Further, out of peripheral vehicles and infrastructure sensors, cooperation nodes that receive transmission of sensor data are decided, and the sensor data received from those and sensor data from sensors in the own vehicle are used to update information possessed by the mini edge server. When communication with the edge server has been restored, the mini edge server is stopped, and data received from the edge server is used in driving support.

### CITATION LIST

### Patent Literature

PATENT LITERATURE 1: International Publication No. WO 2021/002223

### SUMMARY OF THE INVENTION

### Solution to Problem

An in-vehicle device according to a first aspect of the present disclosure is mounted to a vehicle including a driving support device configured to use information from an external server. The in-vehicle device includes: an in-vehicle server capable of executing one or a plurality of sub-functions forming a subset of a function of the external server, the in-vehicle server being configured to use data received from outside and output subset information capable of replacing a part of the information; a function selection unit configured to select, in response to a fact that reception of the information from the external server has been suspended, at least one of the sub-functions executed by the in-vehicle server, in accordance with a priority based on a traffic environment where the vehicle is in; a reception determination unit configured to determine that the reception of the information from the external server has been suspended; and a vehicle inside-outside collaboration device configured to provide, in accordance with determination by the reception determination unit that the reception has been suspended, the subset information from the in-vehicle server to the driving support device.

An operation method for an in-vehicle device according to a second aspect of the present disclosure is for an in-vehicle device mounted to a vehicle including a driving support device configured to use information from an external server. The operation method includes: a step of constructing an in-vehicle server capable of executing one or a plurality of sub-functions forming a subset of a function of the external server, the in-vehicle server being configured to use data received from outside and output subset information capable of replacing a part of the information; a step of determining that reception of the information from the external server has been suspended; and a step of providing, in accordance with determination that the reception has been suspended, the subset information from the in-vehicle server to the driving support device.

A vehicle according to a third aspect of the present disclosure has mounted thereto the in-vehicle device according to any one of the above.

### BRIEF DESCRIPTION OF DRAWINGS

FIG. 1 is a schematic block diagram of an in-vehicle device and components of a vehicle controlled by the in-vehicle device according to a first embodiment of this disclosure.

FIG. 2 is a functional block diagram of the in-vehicle device in the first embodiment of this disclosure.

FIG. 3 schematically shows a stored content of a function module storage storing function modules usable in a mini edge server of the first embodiment of this disclosure.

FIG. 4 shows a priority table referred to when the mini edge server selects a sub-function according to the first embodiment of this disclosure.

FIG. 5 is a flowchart showing a control structure of a computer program that causes a computer to realize the function of the in-vehicle device shown in FIG. 1.

FIG. 6 is a flowchart showing a control structure of a computer program that realizes a step of generating a subset of a server function in the computer program shown in FIG. 5.

FIG. 7 is a block diagram showing an example of a hardware configuration that realizes the in-vehicle device shown in FIG. 1.

FIG. 8 is a block diagram of an in-vehicle device according to a second embodiment of this disclosure.

FIG. 9 is a block diagram showing a hardware configuration of an in-vehicle mini server ECU, which is a computer that realizes the mini edge server according to the first embodiment and the second embodiment of this disclosure.

### DETAILED DESCRIPTION

### Problems to be solved by this Disclosure

If the technology disclosed in PATENT LITERATURE 1 is used, even when communication with the server has been suspended, driving support information can be generated in the mini edge server and can be used in the vehicle. Therefore, there is an excellent effect that driving support for the vehicle can be continued.

However, in order to put the technology disclosed in PATENT LITERATURE 1 into practice, there are further problems to be solved. For example, as described above, other than the edge servers, a large number of cloud services have already been provided. PATENT LITERATURE 1 does not take use of such cloud services into consideration. Further, there is also a problem of, when new services are added in the future, how to cope with those services. Since information processing resources mounted to a vehicle are limited, there is also a problem that necessary services cannot always be sufficiently realized by the mini edge server.

Therefore, an object of this disclosure is to provide an in-vehicle device that can, even when connection with a server cannot be established, flexibly perform as a substitute the function thereof, an operation method therefor, and a vehicle having mounted thereto the in-vehicle device.

### Effect of this Disclosure

As described above, according to this disclosure, it is possible to provide an in-vehicle device that can, even when connection with a server cannot be established, flexibly perform as a substitute the function thereof, an operation method therefor, and a vehicle having mounted thereto the in-vehicle device.

The objects, features, and advantages of this disclosure will become apparent from this specification and the accompanying drawings.

### Description of Embodiment of this Disclosure

In the description below and the drawings, the same components are denoted by the same reference signs. Therefore, detailed descriptions thereof are not repeated. At least some parts of the disclosure described below may be combined together as desired.

(1) An in-vehicle device according to a first aspect of the present disclosure is mounted to a vehicle including a driving support device configured to use information from an external server. The in-vehicle device includes: an in-vehicle server capable of executing one or a plurality of sub-functions forming a subset of a function of the external server, the in-vehicle server being configured to use data received from outside and output subset information capable of replacing a part of the information; a function selection unit configured to select, in response to a fact that reception of the information from the external server has been suspended, at least one of the sub-functions executed by the in-vehicle server, in accordance with a priority based on a traffic environment where the vehicle is in; a reception determination unit configured to determine that the reception of the information from the external server has been suspended; and a vehicle inside-outside collaboration device configured to provide, in accordance with determination by the reception determination unit that the reception has been suspended, the subset information from the in-vehicle server to the driving support device.

When communication with the external server has been suspended, the in-vehicle server is activated and a sub-function selected in accordance with the priority based on the traffic environment is provided. Therefore, it is possible to provide an in-vehicle device that can, even when connection with the server has been suspended, flexibly perform as a substitute the function thereof.

(2) The function selection unit may include: a priority table storage device for storing a priority table defining a priority level of the function for each of one or a plurality of types of the traffic environment; a priority table selection unit configured to identify a traffic environment of the vehicle and select one, out of the priority tables stored in the priority table storage device, that corresponds to the traffic environment; a resource information acquisition unit configured to acquire current dynamic information of information processing resources possessed by the vehicle; and a sub-function selection unit configured to select, in accordance with a priority defined by the priority table selected by the priority table selection unit, the sub-function within a range allowed by the information processing resources, based on the dynamic information acquired by the resource information acquisition unit.

In accordance with the priority defined by the priority table, a sub-function is selected within a range allowed by the status of the information processing resources. Since a sub-function effective within the range of the information processing resources is selected, it is possible to provide an in-vehicle device that can, even when connection with the server has been suspended, flexibly perform as a substitute the function thereof within a possible range.

(3) The priority table selection unit may identify the traffic environment of the vehicle, based on a dynamic map and a position of the vehicle.

Since the dynamic map is transmitted from the server, the priority table selection unit can identify the traffic environment, based on the newest information.

(4) The dynamic information acquired by the resource information acquisition unit may be dynamic information of at least a plurality of information processing resources out of the information processing resources possessed by the vehicle, and the in-vehicle server may distribute a function to a plurality of information processing resources in the information processing resources possessed by the vehicle, thereby processing the function.

The vehicle may possess a plurality of information processing resources. When the sub-function of the in-vehicle server is distributed to and executed by such information processing resources, it is possible to provide an in-vehicle device that can, even when connection with the server has been suspended, flexibly perform as a substitute the function thereof, by effectively using the information processing resources in the vehicle.

(5) The sub-function selection unit may include: a first sub-function selection unit configured to select, in accordance with the priority defined by the priority table selected by the priority table selection unit, the sub-function within the range allowed by the information processing resources, based on the dynamic information acquired by the resource information acquisition unit; and a second sub-function selection unit configured to select another of the sub-functions necessary for execution of the sub-function selected by the first sub-function selection unit.

When, in order to execute a certain sub-function, another sub-function is necessary, the second sub-function selection unit automatically selects the necessary sub-function. Thus, a failure of execution of the selected sub-function at the execution thereof can be prevented, and it is possible to provide an in-vehicle device that can, even when connection with the server has been suspended, flexibly and surely perform as a substitute the function thereof.

(6) The function selection unit may further include a function storage configured to store a function having been executed by the driving support device, in accordance with the determination by the reception determination unit that the reception has been suspended; and the sub-function selection unit may include a sub-function selection unit configured to select, in accordance with the priority defined by the priority table selected by the priority table selection unit, the sub-function within the range allowed by the information processing resources and from functions stored in the function storage, based on the dynamic information acquired by the resource information acquisition unit.

The function storage has stored therein the function having been executed when communication with the external server has been suspended. The sub-function selection unit preferentially selects this function. Therefore, it is possible to provide an in-vehicle device that has a flexible function enabling the in-vehicle device, even when connection with the server has been suspended, to continuously perform as a substitute the function thereof.

(7) The in-vehicle server may decide, for each function selected by the function selection unit, a cooperation node from which data necessary for realizing the function is to be collected.

Each function may require a different type of external data. Since the cooperation node for collecting data for such a function is separately decided, each function can be effectively executed. As a result, it is possible to provide an in-vehicle device that can, even when connection with the server has been suspended, flexibly and efficiently perform as a substitute the function thereof.

(8) The in-vehicle server may decide a cooperation node from which data necessary for realizing functions selected by the function selection unit is to be collected, such that the cooperation node is common among all the selected functions.

Since the cooperation node is decided so as to be common among all the selected functions, the time for deciding the cooperation node can be saved. In addition, the number of cooperation nodes with which communication needs to be performed is reduced in general. As a result, it is possible to provide an in-vehicle device that can, even when connection with the server has been suspended, flexibly and efficiently perform as a substitute the function thereof.

(9) An operation method for an in-vehicle device according to a second aspect of the present disclosure is for an in-vehicle device mounted to a vehicle including a driving support device configured to use information from an external server. The operation method includes: a step of constructing an in-vehicle server capable of executing one or a plurality of sub-functions forming a subset of a function of the external server, the in-vehicle server being configured to use data received from outside and output subset information capable of replacing a part of the information; a step of selecting, in response to a fact that reception of the information from the external server has been suspended, one of the sub-functions executed by the in-vehicle server, in accordance with a priority based on a traffic environment where the vehicle is in; a step of determining that the reception of the information from the external server has been suspended; and a step of providing, in accordance with determination that the reception has been suspended, the subset information from the in-vehicle server to the driving support device.

When communication with the external server has been suspended, the in-vehicle server is activated and a sub-function selected in accordance with the priority based on the traffic environment is provided. Therefore, it is possible to provide an operation method for an in-vehicle device that can, even when connection with the server has been suspended, flexibly perform as a substitute the function thereof.

(9) A vehicle according to a third aspect of the present disclosure has mounted thereto the in-vehicle device according to any one of the above.

When communication with the external server has been suspended, the in-vehicle server is activated and a sub-function selected in accordance with the priority based on the traffic environment is provided, as in the in-vehicle device described above. Therefore, even when connection with the server has been suspended, the function is flexibly substituted for and performed. As a result, it is possible to provide a vehicle that can, when suspension of the server has occurred, continuously use a subset of the function having been provided by the server.

### Details of Embodiments of this Disclosure

### I. First Embodiment

Hereinafter, specific examples of an in-vehicle device, a control method therefor, and a vehicle according to the first embodiment of this disclosure will be described with reference to the drawings. The present disclosure is not limited to these examples and is indicated by the claims, and is intended to include meaning equivalent to the claims and all modifications within the scope of the claims. Some parts of the disclosure described below may be combined together as desired.

### 1. Configuration

### (1) Entire Configuration

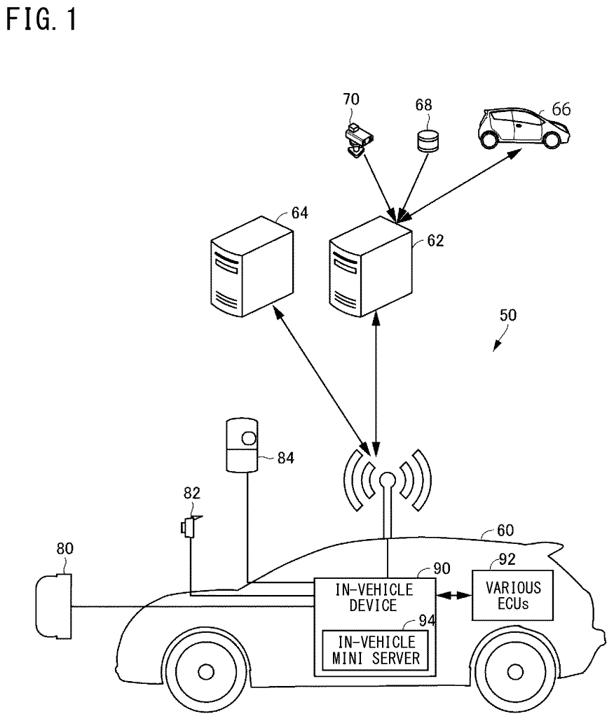

FIG. 1 shows a block diagram of a driving support system 50 according to this disclosure. With reference to FIG. 1, the driving support system 50 includes an edge server 62, and a cloud server 64 which distributes traffic information and other various types of information. The function of the edge server 62 is to: collect sensor information from a vehicle 66, and infrastructure sensors such as a LiDAR (Light Detection And Ranging) 68 and a camera 70; integrate the sensor information with a high-precision map stored in advance; generate information (driving support information) that supports driving; and distribute the driving support information to vehicles. The driving support information includes, for example, a dynamic map regarding a traffic environment and a traffic situation, and the like. The traffic environment here denotes a road shape such as, mainly, an intersection, a branch merging point, a straight road, or a curve. The traffic situation denotes a road state such as whether or not there is an occurrence of a congestion, whether or not there is a section in which traffic is being regulated, whether or not there is an occurrence of an accident, or whether or not there is a vehicle that is stopped.

The driving support system 50 further includes a vehicle 60 communicable by using wireless communication with external servers such as the edge server 62 and the cloud server 64. The driving support system 50 further includes an in-vehicle device 90 which is mounted to the vehicle 60 and which uses information obtained from the edge server 62 in driving support for the vehicle, and information obtained from the cloud server 64 in various usages. The driving support system 50 further includes: a millimeter wave radar 80, an in-vehicle camera 82, and a LiDAR 84, which are in-vehicle sensors connected to the in-vehicle device 90; and various ECUs (Electronic Control Unit) 92 for electronically controlling mechanical parts and the like of components of the vehicle 60 through cooperation with the in-vehicle device 90.

In this embodiment, the in-vehicle device 90 is substantially a computer, and realizes an in-vehicle mini server 94 by executing a predetermined program. The in-vehicle mini server 94 executes a subset of the function of an edge server and a subset of the function of a cloud server. By executing the subset of the function of each server like this, the in-vehicle mini server 94 generates, based on data collected by the in-vehicle mini server 94, a part of information that would normally be generated by the edge server and the cloud server. This information generated by the in-vehicle mini server 94 will be referred to as, in contrast of information provided by the edge server and the cloud server, subset information thereof.

The subset information here is not about the content of information, and is about the type of the information. The subset information generated by the in-vehicle mini server 94 is generated according to a subset of the function of each server. Therefore, this subset information is information of the same type as that of a part of information provided by each server. Therefore, by using the subset information so as to replace a part of information that should have been provided from a server, the in-vehicle device 90 can utilize the part of the information. However, the data and process serving as the source of the subset information are different from those by the server. Therefore, the content does not necessarily match the content of information provided by the server.

### (2) In-Vehicle Device

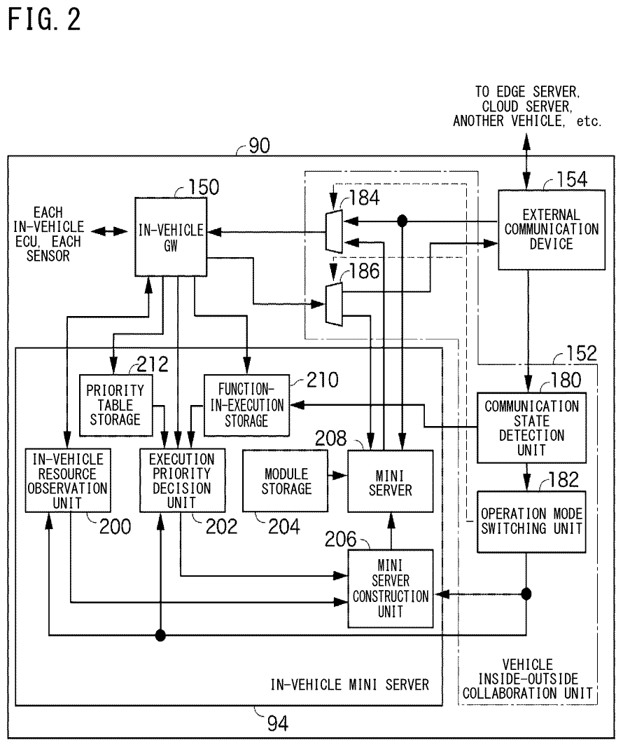

With reference to FIG. 2, the in-vehicle device 90 includes: an external communication device 154 capable of performing wireless communication with an external wireless base station, another vehicle, and the like; and an in-vehicle GW (Gateway) 150 provided between an in-vehicle network and the external communication device 154. The function of the in-vehicle GW 150 is to transmit, to the edge server 62, information obtained from the in-vehicle sensors and the various ECUs 92 (see FIG. 1) mounted to the vehicle. In addition, the in-vehicle GW 150 performs a process of, for example, distributing, to the in-vehicle device 90, information received by the external communication device 154 from the edge server 62 or the cloud server 64. The in-vehicle device 90 further includes a vehicle inside-outside collaboration unit 152 connected to the external communication device 154, the in-vehicle GW 150, and the in-vehicle mini server 94. The function of the vehicle inside-outside collaboration unit 152 is to control the flow of data between the in-vehicle GW 150, the external communication device 154, and the in-vehicle mini server 94 in accordance with the status of communication by the external communication device 154, thereby controlling collaboration between the inside and the outside of the vehicle 60.

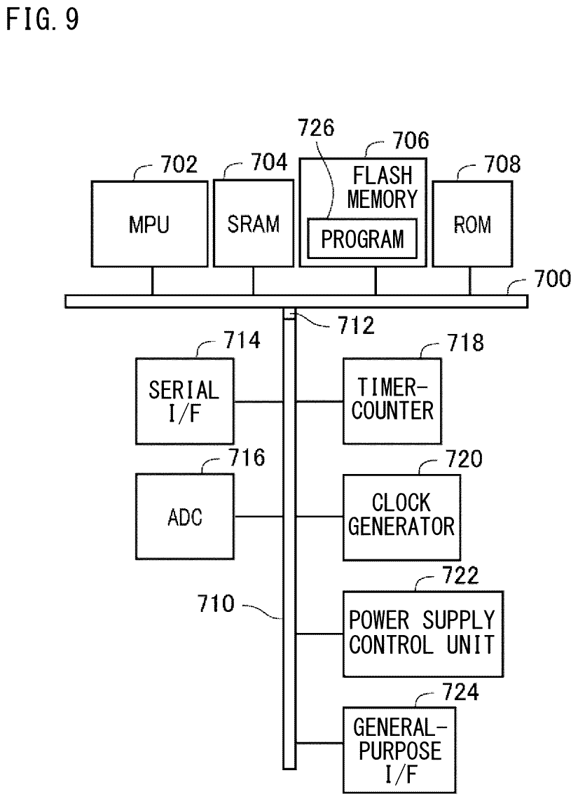

The in-vehicle mini server 94 includes an in-vehicle resource observation unit 200 for observing the dynamic state such as the load of information processing resources such as the in-vehicle network and the various ECUs 92 mounted to the vehicle 60 through the in-vehicle GW 150. The in-vehicle mini server 94 further includes a priority table storage 212 for storing a table referred to as a priority table transmitted from the edge server 62 through the external communication device 154 and the in-vehicle GW 150. The hardware configuration of the in-vehicle mini server 94 will be described later with reference to FIG. 9.

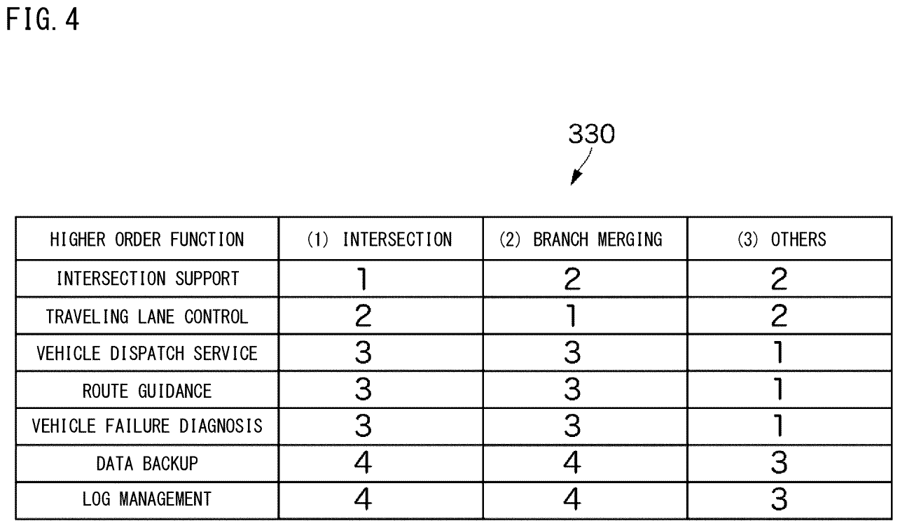

The priority table will be described later with reference to FIG. 4. The priority table is a table for deciding what function the in-vehicle mini server 94 is caused to execute at what priority level, when communication between the external communication device 154 and an external server has been suspended. The priority table is created in advance, and is stored in the edge server 62. A plurality of the priority tables are prepared in accordance with the traffic situation where the vehicle is in.

The in-vehicle device 90 further includes: a mini server 208 being the body of the in-vehicle mini server; a module storage 204 storing function modules executable by the mini server 208; and a function-in-execution storage 210 for storing a function in execution such as a service in use by the vehicle 60 when communication with a server by the external communication device 154 has been suspended. The in-vehicle device 90 further includes an execution priority decision unit 202 for selecting an optimum one, out of the priority tables stored in the priority table storage 212, in accordance with the traffic situation where the vehicle 60 is in. The traffic situation can be identified based on the road shape shown in the dynamic map and the position of the vehicle 60. The dynamic map is usually downloaded from the edge server 62 and thus is updated to the newest information. The in-vehicle device 90 further includes a mini server construction unit 206. The function of the mini server construction unit 206 is to construct the mini server 208 so as to select, from the module storage 204, a function module corresponding to the function that should be executed by the mini server 208, and execute the function module. At this time, the mini server construction unit 206 uses the priority table selected by the execution priority decision unit 202, the function in execution stored in the function-in-execution storage 210, and the dynamic state of the in-vehicle information processing resources observed by the in-vehicle resource observation unit 200.

The vehicle inside-outside collaboration unit 152 includes a communication state detection unit 180 for detecting the communication state with external servers by the external communication device 154 and for notifying, in response to a fact that communication with any one of the external servers has been suspended, the function-in-execution storage 210 in the in-vehicle mini server 94 of the detection of the suspension. The vehicle inside-outside collaboration unit 152 further includes an operation mode switching unit 182. The function of the operation mode switching unit 182 is to switch, in response to a fact that the suspension of communication with an external server has been detected by the communication state detection unit 180, the operation mode of the in-vehicle device 90 from a normal mode to a suspension mode, and to notify the in-vehicle mini server 94 of the switching of the operation mode. In the normal mode, the vehicle inside-outside collaboration unit 152 operates based on communication with the external servers. In the suspension mode, the vehicle inside-outside collaboration unit 152 operates using information generated by the in-vehicle mini server 94, instead of the communication with the external servers. The vehicle inside-outside collaboration unit 152 further includes a selection unit 184 which is controlled by the operation mode switching unit 182, and which is switched so as to transmit information received by the external communication device 154 to the in-vehicle GW 150 during the normal mode, and transmit the output of the mini server 208 to the in-vehicle GW 150 during the suspension mode. The vehicle inside-outside collaboration unit 152 further includes a selection unit 186 which is controlled by the operation mode switching unit 182, and which is switched so as to transmit the output of the in-vehicle GW 150 to the external communication device 154 during the normal mode, and to the mini server 208 during the suspension mode.

### (3) Function Module Configuration

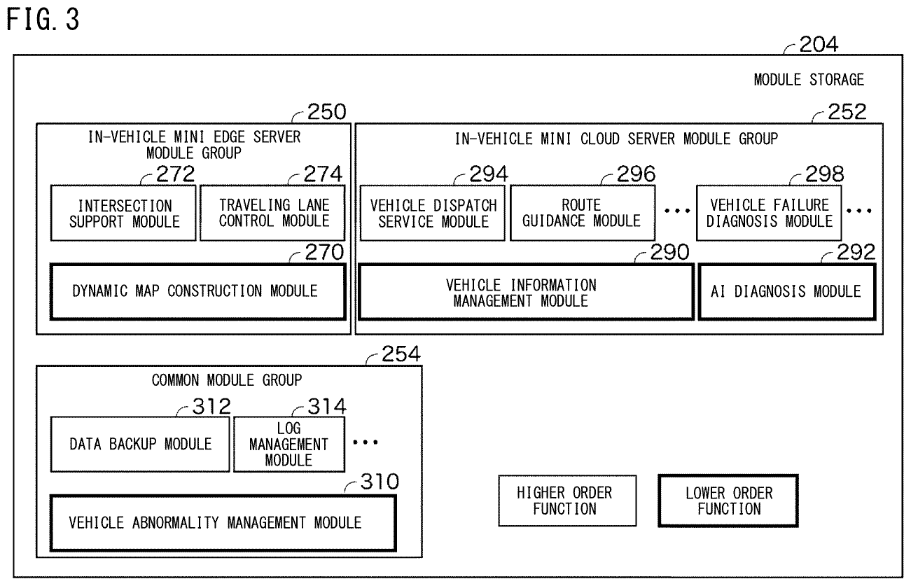

FIG. 3 shows an example of function module groups stored in the module storage 204. These function module groups provide functions of the same types as those of the functions provided by the external servers. However, when each individual function is focused on, due to restriction of resources usable by the vehicle 60, it is difficult to completely substitute for the function. Therefore, the majority of the function modules can be said to be sub-function modules with the meaning of providing parts of the functions of the external servers. However, in the following, such a sub-function module will be simply referred to as “function module”.

With reference to FIG. 3, the function module groups stored in the module storage 204 are roughly classified into three groups. The first one is an in-vehicle mini edge server module group 250 for realizing a subset of the function of the edge server 62. The second one is an in-vehicle mini cloud server module group 252 for realizing a subset of the function of the cloud server 64. The third one is a common module group 254 used by both of an in-vehicle mini edge server and an in-vehicle mini cloud server.

The in-vehicle mini edge server module group 250 includes, for example: an intersection support module 272 to be used when the vehicle is in the vicinity of an intersection; a traveling lane control module 274 to be used when the vehicle is traveling on a road having a plurality of lanes; and a dynamic map construction module 270. The dynamic map construction module 270 is a function module that is required in common by the intersection support module 272 and the traveling lane control module 274. That is, the intersection support module 272 and the traveling lane control module 274 form a function module group of a first layer, and the dynamic map construction module 270 is a function module of a second layer serving as the base for the function module group of the first layer. The layered structure like this also applies to the case of the in-vehicle mini cloud server module group 252 and the common module group 254. The function module group of the first layer can include a plurality of other modules in addition to the intersection support module 272 and the traveling lane control module 274.

The function module group of the first layer of the in-vehicle mini cloud server module group 252 includes a vehicle dispatch service module 294, a route guidance module 296, a vehicle failure diagnosis module 298, and the like. The function module group of the second layer of the in-vehicle mini cloud server module group 252 includes a vehicle information management module 290 which manages basic vehicle information of the vehicle 60, an AI (Artificial Intelligence) diagnosis module 292 necessary for vehicle diagnosis, etc., and the like.

The function module group of the first layer of the common module group 254 includes a data backup module 312 for backing up data of the in-vehicle device 90 into a cloud server. The function module group of the first layer further includes: a log management module 314 which performs a process of writing out the operation status of the in-vehicle device 90 as a temporary log into a storage device in the vehicle, and periodically uploading the operation status to the cloud server; and the like.

The function module group of the second layer of the common module group 254 includes a vehicle abnormality management module 310. The vehicle abnormality management module 310 is a function module used in common by the data backup module 312 and the log management module 314.

The mini server construction unit 206 uses various conditions in order to select these function modules. These conditions are, for example: how much surplus is in the information processing resources distributed over the entire vehicle; what environment is the traffic environment where the vehicle 60 is in; and the like. The traffic environment can be identified based on the road shape shown in the dynamic map and the position of the vehicle 60. The dynamic map has been downloaded from the edge server 62 when communication with the edge server 62 has been possible, and thus, is the newest information that can be acquired by the mini server construction unit 206. Therefore, the mini server construction unit 206 can select a function module, based on the traffic environment that is as new as possible. The information processing resources include the in-vehicle device 90, the various ECUs 92 which execute a part of the function of the in-vehicle mini server 94 together with the in-vehicle device 90, the in-vehicle network connecting these, and the like.

### (4) Priority Table

FIG. 4 shows an example of the priority table received by the priority table storage 212 in FIG. 2 from the edge server 62 and stored in the priority table storage 212. When designating a function of the mini server 208, the mini server construction unit 206 refers to this priority table.

With reference to FIG. 4, a priority table 330 according to this embodiment defines the priority of each function module under three types, i.e., intersection, branch merging, and others, in accordance with the traffic environment where the vehicle is in.

For example, in the case of intersection, the intersection support is at the first priority, the traveling lane control is at the second priority, and the vehicle dispatch service, the route guidance, and the vehicle failure diagnosis are each at the third priority. In this embodiment, the smaller the number is, the higher the priority is.

Those in FIG. 4 are only the function modules of the first layer in FIG. 3. With respect to the function modules of the second layer, when a function module of the first layer has been selected, a function module that is required by the selected function module is automatically selected. Accordingly, it is possible to prevent a situation where, although a necessary function module of the first layer has been selected, the function cannot be executed since the function module of the second layer necessary for the execution thereof is absent.

In this embodiment, this priority table is distributed to each vehicle from the edge server 62. However, this embodiment is not limited to such an embodiment. For example, the manufacturer of the in-vehicle device may create the priority table in advance and incorporate the priority table into the in-vehicle mini server, or if there is a cloud server that performs a service of distributing such a priority table, the priority table may be downloaded therefrom. The classification of the traffic environment for which the priority table is prepared need not necessarily be of the three types shown in FIG. 4, and may be of two types, four types, or more. In some cases, a single priority table may be used.

### (5) Computer Program

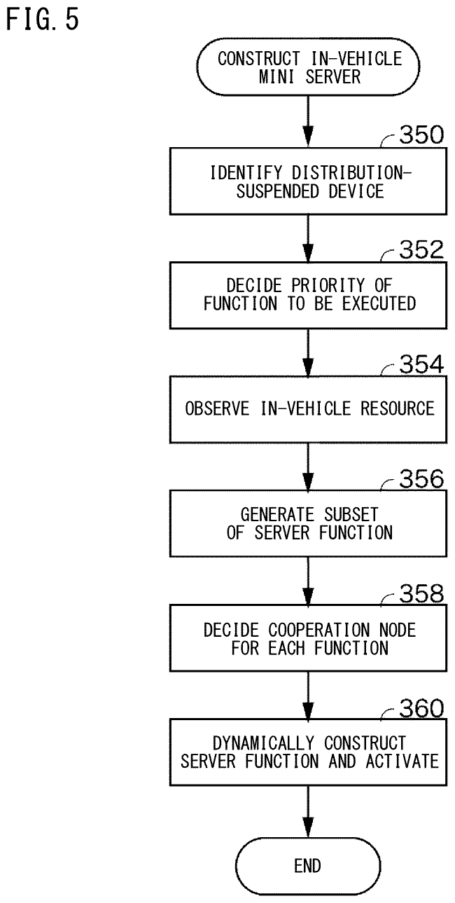

FIG. 5 is a flowchart showing a control structure of a computer program for causing a computer to function as the in-vehicle device 90 according to this embodiment. With reference to FIG. 5, this program includes step 350, which is executed when, for example, distribution of data from the edge server 62 has been suspended, of identifying the device (service) for which the distribution has been suspended, and storing information thereof into the function-in-execution storage 210 shown in FIG. 2. This program further includes step 352, by the execution priority decision unit 202, of deciding an appropriate priority table, based on the traffic environment of the vehicle 60, out of the priority tables stored in the priority table storage 212.

This program further includes step 354, by the in-vehicle resource observation unit 200, of observing the static state and the dynamic state of the information processing resources that can be used in the vehicle 60. Examples of the static state of the information processing resources include the specification of a CPU (Central Processing Unit), the operation clock, the memory capacity, the communication capacity of the network, and the like. Examples of the dynamic state include the load state of the CPU, the free space of the memory, the throughput of the network, the delay time, and the like. Based on the information when communication with the edge server 62 has been possible, a dynamic map is stored in the in-vehicle device 90. By use of this dynamic map and the information regarding the position of the vehicle, at least the traffic environment of the vehicle at activation of the mini server can be determined.

This program further includes step 356 of generating, based on the suspended service identified in step 350, the priority table decided in step 352, and the in-vehicle information processing resources observed in step 354, a subset of a server function to be executed by the mini server 208 out of server functions having been provided by the external servers. This program further includes step 358 of deciding cooperation nodes for each function forming the subset generated in step 356. Each cooperation node is a node, among peripheral communication nodes such as the infrastructure sensors and vehicles, from which sensor data to be used for generating information regarding the service is collected. This program further includes step 360 of dynamically constructing and activating the mini server 208 so as to execute each function by collecting sensor data from the cooperation nodes decided in step 358 with respect to the subset of the server function generated in step 356. After step 360, execution of this program ends.

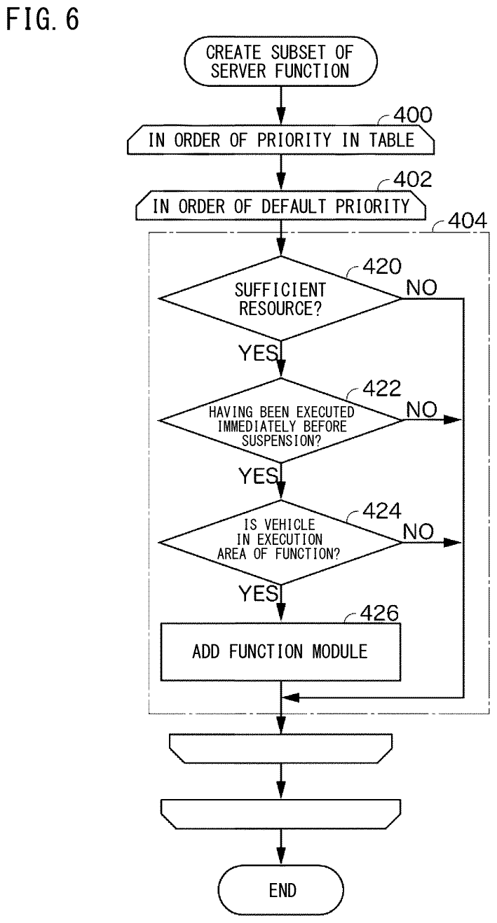

FIG. 6 shows a flowchart showing a control structure of a computer program executed in step 356 in FIG. 5. With reference to FIG. 6, step 356 in FIG. 5 includes step 400 of executing the following step 402, starting sequentially from the server function having the priority 1 in the priority table selected in step 352 in FIG. 5.

Step 402 includes step 404 where, when the priority being processed is assigned to a plurality of server functions, step 404 is executed in the order of the priorities provided by default to the server functions. The default priorities here are assumed to have been set in advance such that the same priority is not assigned to a plurality of server functions by the manufacturer of the in-vehicle device 90, the manufacturer of the vehicle 60, the seller of the vehicle 60, or the like, for example. It may be configured such that a user can set the default priorities.

Step 404 includes step 420 of branching, as a result of the observation in step 354 in FIG. 5, the flow of the control in accordance with whether or not there are resources sufficient for executing the server function being processed. Step 404 further includes step 422 of branching, when the determination in step 420 is positive, the flow of the control in accordance with whether or not (whether or not the server function has been used, or whether or not an application has been executed) the server function as the determination target has been executed in the in-vehicle device 90 immediately before the suspension of communication with the external server. Step 404 further includes step 424 of branching, when the determination in step 422 is positive, the flow of the control in accordance with whether or not the current position of the vehicle is in the execution area of the function being the determination target. Step 404 further includes step 426 of adding, when the determination in step 424 is positive, a function module corresponding to the function being the determination target as a function of the mini server, and ending step 404. When the determination in each step 420, 422, 424 is negative, addition of the function module being the determination target is not performed, and step 404 ends.

### 2. Operation

### (1) During Normal State

With reference to FIG. 1, when communication with all the external servers such as the edge server 62 and the cloud server 64 is being normally performed, the operation mode switching unit 182 shown in FIG. 2 has set the operation mode to the normal mode. That is, the operation mode switching unit 182 switches the selection unit 184 such that the external communication device 154 can provide data received from the external servers to the in-vehicle GW 150. The operation mode switching unit 182 switches the selection unit 186 such that sensor data and data that should be transmitted to the external servers regarding the vehicle 60, those data being outputted by the in-vehicle GW 150, are transmitted to the external servers through the external communication device 154.

The in-vehicle GW 150 transmits data received from the external servers, to an automated driving ECU. In addition, the in-vehicle GW 150 transmits sensor data outputted by the millimeter wave radar 80, the in-vehicle camera 82, and the LiDAR 84 which are mounted to the vehicle 60, to the external servers through the external communication device 154.

While this normal mode is executed, the in-vehicle mini server 94 is at rest in this embodiment. However, even during the normal mode, the in-vehicle mini server 94 may be caused to operate, and the selection units 184 and 186 may be switched such that the output of the in-vehicle mini server 94 is used immediately after communication with the external servers has been suspended.

The function-in-execution storage 210 is always monitoring and recording the function executed by the automated driving ECU through the in-vehicle GW 150.

During a normal state, the priority table received from the edge server 62 through the external communication device 154 is separated from the received data by the in-vehicle GW 150 and stored into the priority table storage 212.

### (2) Suspension Mode

When communication with any one of the external servers has been suspended, the communication state detection unit 180 detects the suspension and notifies the function-in-execution storage 210 of the suspension. The function-in-execution storage 210 stores information indicating the function executed by the automated driving ECU at that time. The communication state detection unit 180 also notifies the operation mode switching unit 182 of the communication suspension.

In response to this notification, the operation mode switching unit 182 switches the operation mode from the normal mode to the suspension mode. The operation mode switching unit 182 switches the selection unit 184 such that, with respect to the communication with the external server for which the communication has been suspended, the selection unit 184 provides the output of the mini server 208 to the in-vehicle GW 150. In addition, the selection unit 186 is switched such that the output of the in-vehicle GW 150 is provided to the mini server 208. At this time, with respect to the external servers for which communication is continued, the operation mode switching unit 182 switches the selection unit 184 and the selection unit 186 such that data flows in the same paths as those during the normal state. In addition, the operation mode switching unit 182 notifies the in-vehicle resource observation unit 200, the execution priority decision unit 202, and the mini server construction unit 206 that the operation mode has been switched to the suspension mode.

When the execution priority decision unit 202 has been notified of the suspension of communication, the execution priority decision unit 202 reads out a priority table suitable for the traffic environment at the current position of the vehicle, out of the priority tables stored in the priority table storage 212. The traffic environment can be identified based on the road shape shown in the dynamic map and the position of the vehicle 60. In addition, the execution priority decision unit 202 reads out information regarding the service from the external server for which the process has been suspended, out of the processes which have been executed by the automated driving ECU at the time of the communication suspension and which are stored in the function-in-execution storage 210. The execution priority decision unit 202 provides the thus read out priority information and information regarding the function in execution, to the mini server construction unit 206.

Meanwhile, the in-vehicle resource observation unit 200 observes the dynamic state (such as the load of the CPU, the use status of the memory, etc.) of other ECUs in the vehicle and the dynamic state (the throughput, the delay time) and the like of the network, through the in-vehicle GW 150, and provides the result to the mini server construction unit 206.

The mini server construction unit 206 selects, according to the program shown in FIG. 6, a function module corresponding to the function that should be executed by the mini server 208 out of the function modules stored in the module storage 204, and adds the selected function module to the function of the mini server 208. The function module that is added is a function module of the first layer corresponding to the function that should be executed by the mini server 208 and a function module of the second layer necessary for executing the function module. At this time, the mini server construction unit 206 selects the function modules within an allowable range by using the priority table provided from the execution priority decision unit 202 and the information regarding the function module in execution, and the dynamic state of the in-vehicle resources provided from the in-vehicle resource observation unit 200. In actuality, the mini server construction unit 206 writes the selected function modules into an initial setting file that specifies the function modules that should be read when the mini server 208 is activated. In some cases, when the mini server construction unit 206 executes step 420 in FIG. 6, with respect to the function module of the first layer, the function module of the second layer required by the function module has not been added yet to the function of the mini server 208. In such a case, the mini server construction unit 206 needs to determine whether or not there are in-vehicle resources necessary for executing both of the function module of the first layer and the function module of the second layer.

This determination is made according to a criterion, for example, whether or not the usable memory capacity and the memory capacity to be consumed due to addition of the new function modules are within the range (e.g., within 80%) of the memory capacity usable by the mini server 208. A criterion such as, due to addition of the new function modules, whether or not the predicted average traffic of the network exceeds an allowable amount (e.g., 65%), whether or not the average operating rate of the CPU is lower than or equal to a predetermined threshold (e.g., 80%), or the like may be used in combination. When a plurality of criteria are used, if any one of the criteria is not satisfied, the mini server construction unit 206 does not add the modules.

In this manner, the mini server construction unit 206 adds all the function modules, among the necessary function resources, that are executable in the vehicle 60 to the initial setting file of the mini server 208. Then, the mini server construction unit 206 decides, for each function, nodes (cooperation nodes) from which the mini server 208 collects sensor data, out of the communication nodes such as peripheral infrastructure sensors and vehicles, and adds the nodes to the initial setting file of the mini server 208. After having written the necessary information into the initial setting file of the mini server 208 in this manner, the mini server construction unit 206 activates the mini server 208. At activation, the mini server 208 first reads out this initial setting file, reads out the recorded function modules from the module storage 204, and incorporates the read-out function modules into the function of the mini server 208. Based on the description of the initial setting file, the mini server 208 further collects sensor data from the cooperation nodes decided for each function, analyzes the sensor data, and starts provision of a subset of the function having been provided by the external server for which the communication has been suspended.

After the mini server 208 has been activated, the mini server 208 updates the position of the mini server 208, based on the sensors mounted to the vehicle 60, the high-precision map stored in the vehicle 60, and the sensor data received from the cooperation nodes. In addition, the mini server 208 also updates by itself the vehicles and infrastructure sensors forming the cooperation nodes, in accordance with the position of the mini server 208. Based on the dynamic state of the in-vehicle information processing resources acquired in step 354 in FIG. 5, the in-vehicle mini server 94 also causes other ECUs to execute, in a distributed manner, a part of the function executed by the in-vehicle mini server 94. Alternatively, the in-vehicle mini server 94 basically executes each function, and only when the load of the in-vehicle mini server 94 has become large, other ECUs may be used. Still alternatively, while most of the functions executed by the in-vehicle mini server 94 are assigned to other ECUs, the in-vehicle mini server 94 may perform only control of those ECUs.

Then, when communication with the external server for which the communication had been suspended has been restored, the mini server 208 stops the function, and the operation mode switching unit 182 switches the selection units 184 and 186 to the connections in the normal mode, whereby the in-vehicle device 90 is restored to the normal mode.

### 3. Hardware Configuration

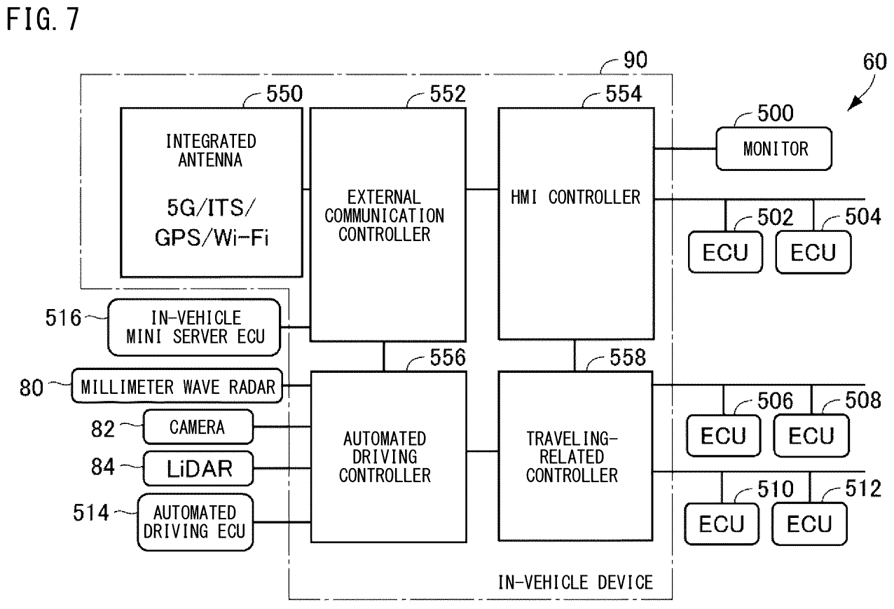

FIG. 7 shows a hardware configuration of the in-vehicle device 90 mounted to the vehicle 60 and peripheries of the in-vehicle device 90 according to this embodiment. With reference to FIG. 7, the in-vehicle device 90 includes: an HMI (Human-Machine Interface) controller 554 connected to an in-vehicle LAN (Local Area Network); and an external communication controller 552 connected to the in-vehicle LAN, similarly to the HMI controller 554. The in-vehicle device 90 further includes an integrated antenna 550 connected to the external communication controller 552. The integrated antenna 550 functions as an antenna for the 5th-generation mobile communication system (so-called “5G”), Intelligent Transport Systems (ITS), GPS (Global Positioning System) being one type of GNSS (Global Navigation Satellite System), and Wi-Fi. The in-vehicle device 90 further includes: an automated driving controller 556 connected to the HMI controller 554 and the external communication controller 552 through the in-vehicle LAN; and a traveling-related controller 558 connected to the in-vehicle LAN.

The HMI controller 554 has connected thereto a monitor 500, a plurality of ECUs 502, 504, and the like.

The automated driving controller 556 has connected thereto an automated driving ECU 514, in addition to the millimeter wave radar 80, the in-vehicle camera 82, and the LiDAR

The traveling-related controller 558 has connected thereto a plurality of ECUs 506, 508, 510, and 512, and the like for electronically controlling each component related to traveling of the vehicle.

In this embodiment, an in-vehicle mini server ECU 516 is connected to the external communication controller 552. Through cooperation with the in-vehicle device 90, the in-vehicle mini server ECU 516 substantially realizes the mini server function as a part of the in-vehicle device 90. The ECUs 502, 504, 506, 508, 510, and 512, and the automated driving ECU 514 are each substantially a computer, and each have a CPU, a memory, and a communication function. Since the in-vehicle mini server ECU 516 causes these components to execute, in a distributed manner, the function of the mini server, these resources can be effectively used and a stable function of the mini server can be provided.

### II. Second Embodiment

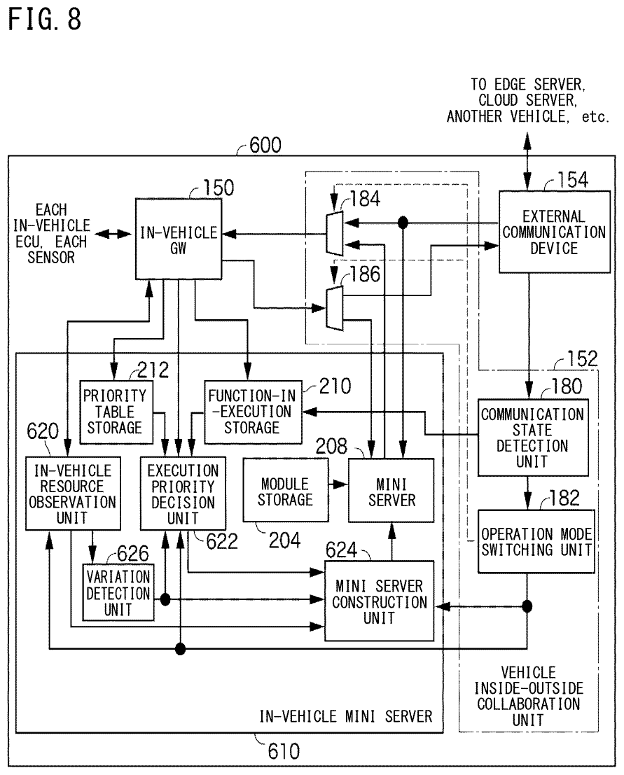

FIG. 8 is a block diagram of an in-vehicle device 600 according to a second embodiment of this disclosure. Differences from the in-vehicle device 90 shown in FIG. 2 are that the in-vehicle device 600 includes an in-vehicle resource observation unit 620 in place of the in-vehicle resource observation unit 200 in FIG. 2 and an execution priority decision unit 622 in place of the execution priority decision unit 202. The in-vehicle device 600 is further different from the in-vehicle device 90 in that the in-vehicle device 600 includes a mini server construction unit 624 in place of the mini server construction unit 206 and newly includes a variation detection unit 626. The variation detection unit is for providing an instruction indicating reconstruction of the mini server 208 to the execution priority decision unit 622 and the mini server construction unit 624, when a predetermined change has occurred in the in-vehicle resources, according to the output of the in-vehicle resource observation unit 620.

The functions of the in-vehicle resource observation unit 620, the execution priority decision unit 622, and the mini server construction unit 624 are basically the same as those of the in-vehicle resource observation unit 200, the execution priority decision unit 202, and the mini server construction unit 206 shown in FIG. 2. However, the in-vehicle resource observation unit 620 is different from the in-vehicle resource observation unit 200 shown in FIG. 2 in that the in-vehicle resource observation unit 620 also provides the output thereof to the variation detection unit 626. The execution priority decision unit 622 is different from the execution priority decision unit 202 in FIG. 2 in that the execution priority decision unit 622 decides the execution priority not only when having received a notification of switching to the suspension mode from the operation mode switching unit 182, but also when having received an instruction to reconstruct the mini server 208 from the variation detection unit 626. The mini server construction unit 624 reconstructs the mini server 208 when having received a notification of switching to the suspension mode from the operation mode switching unit 182. However, in addition to that, the mini server construction unit 624 is different from the mini server construction unit 206 shown in FIG. 2 in that the mini server construction unit 624 reconstructs the mini server 208 also when having received an instruction for reconstruction from the variation detection unit 626.

In this embodiment, the operations of the in-vehicle device 600 during the normal mode and when the operation mode has been switched from the normal mode to the suspension mode are the same as those in the in-vehicle device 90 of the first embodiment. However, this embodiment is different from the first embodiment in that, when some large change has occurred in the dynamic state in the vehicle, the variation detection unit 626 detects the change, and the mini server 208 is reconstructed in accordance with the new situation and activated. To do this, the variation detection unit 626 notifies the execution priority decision unit 622 and the mini server construction unit 624 of this change.

Said some large change is, for example, occurrence of a large surplus in the in-vehicle resources, or occurrence of a large reduction thereof. For example, the time when the delay time in communication in the vehicle has become larger than a threshold, the time when the load (operating ratio) of the CPU executing the function of the mini server 208 has exceeded a predetermined threshold, or the like can be considered to correspond to such a change. With this configuration, not only at activation of the mini server but also after activation thereof, the function of the mini server 208 can be flexibly rearranged in accordance with the situation, and a subset of the function of the external server for which the communication has been suspended can be realized in the vehicle.

### III. Hardware Configuration of In-Vehicle Mini Server ECU 516

With reference to FIG. 9, the in-vehicle mini server ECU 516 (see FIG. 7) which realizes the in-vehicle mini server 94 according to the first embodiment described above and an in-vehicle mini server 610 according to the second embodiment includes: an MPU (Micro-Processing Unit) 702 as a processor; a high speed bus 700 having connected thereto the MPU 702; an SRAM (Static Random Access Memory) 704 connected to the high speed bus 700; a flash memory 706 connected to the high speed bus 700; and a ROM (Read-Only Memory) 708 connected to the high speed bus 700. In the SRAM 704, data and the like necessary for execution of programs is held. The SRAM 704 corresponds to the priority table storage 212 and the function-in-execution storage 210 shown in FIG. 2 and FIG. 8. In the flash memory 706, a program 726 for realizing the function realized by the in-vehicle mini server 610 is stored. The flash memory 706 further functions as the function module storage 204 shown in FIG. 2, FIG. 3, and FIG. 8. In the ROM 708, a boot up program for the MPU 702 and the like are stored.

The in-vehicle mini server ECU 516 further includes: a low speed bus 710 connected through a bridge 712 to the high speed bus 700; and a serial I/F (Interface) 714, an ADC (Analog-to-Digital Converter) 716, a timer-counter 718, a clock generator 720, a power supply control unit 722, and a general-purpose I/F 724, which are each connected to the low speed bus 710. The serial I/F 714 is connected to an in-vehicle network (not shown), and is for receiving information necessary for the in-vehicle mini server ECU 516 to operate as the in-vehicle mini servers 94 and 610 through the in-vehicle network.

The mechanics of the operation of the MPU is well known, and what is meaningful in the embodiment is the function realized by the program executed by the MPU. Therefore, in the following description, the operation of the MPU itself is not described.

### IV. Modification

In the above second embodiment, in accordance with a large change in the in-vehicle resources, the function of the mini server 208 is rearranged. However, this disclosure is not limited to such an embodiment. For example, during communication suspension, the execution priority decision unit 622 and the mini server construction unit 624 may be caused to operate every certain period of time, whereby the function of the mini server 208 may be rearranged. Alternatively, an instruction to rearrange the function of the mini server 208 may be manually provided.

In the above embodiments, the cooperation nodes are separately decided for each function module. Accordingly, each function module can use data necessary for itself, and each function module can be caused to efficiently operate. However, this disclosure is not limited to such an embodiment. The same cooperation nodes may be used for all the function modules. Accordingly, the time for deciding the cooperation nodes can be saved. When one set of the cooperation nodes is used like this, the communication amount with the cooperation nodes can be suppressed. As a result, the function of each function module can be efficiently used. The function modules may be divided into several groups, and the same cooperation nodes may be decided for each group. These methods for deciding the cooperation nodes may be combined as appropriate in accordance with change in the traffic environment.

The embodiments disclosed herein are merely illustrative in all aspects and should be considered not restrictive. The scope of this disclosure is defined by the scope of the claims rather than the detailed description of the disclosure, and is intended to include meaning equivalent to the scope of the claims and all modifications within the scope.

### REFERENCE SIGNS LIST

50 driving support system
60, 66 vehicle
62 edge server
64 cloud server
68, 84 LiDAR
70 camera
80 millimeter wave radar
82 in-vehicle camera
90, 600 in-vehicle device
92 various ECUs
94 in-vehicle mini server
150 in-vehicle GW
152 vehicle inside-outside collaboration unit
154 external communication device
180 communication state detection unit
182 operation mode switching unit
184, 186 selection unit
200, 620 in-vehicle resource observation unit
202, 622 execution priority decision unit
204 module storage
206, 624 mini server construction unit
208 mini server
210 function-in-execution storage
212 priority table storage
250 in-vehicle mini edge server module group
252 in-vehicle mini cloud server module group
254 common module group
270 dynamic map construction module
272 intersection support module
274 traveling lane control module
290 vehicle information management module
292 AI diagnosis module
294 vehicle dispatch service module
296 route guidance module
298 vehicle failure diagnosis module
310 vehicle abnormality management module
312 data backup module
314 log management module
330 priority table
350, 352, 354, 356, 358, 360, 400, 402, 404, 420, 422, 424, 426 step
500 monitor
502, 504, 506, 508, 510, 512 ECU
514 automated driving ECU
516 in-vehicle mini server ECU
550 integrated antenna
552 external communication controller
554 HMI controller
556 automated driving controller
558 traveling-related controller
626 variation detection unit
700 high speed bus
702 MPU
704 SRAM
706 flash memory
708 ROM
710 low speed bus
712 bridge
714 serial I/F
716 ADC
718 timer-counter
720 clock generator
722 power supply control unit
724 general-purpose I/F
726 program

1. An in-vehicle device mounted to a vehicle including a driving support device configured to use information from an external server, the in-vehicle device comprising:
an in-vehicle server capable of executing one or a plurality of sub-functions forming a subset of a function of the external server, the in-vehicle server being configured to use data received from outside and output subset information capable of replacing a part of the information;
a function selection unit configured to select, in response to a fact that reception of the information from the external server has been suspended, at least one of the sub-functions executed by the in-vehicle server, in accordance with a priority based on a traffic environment where the vehicle is in;
a reception determination unit configured to determine that the reception of the information from the external server has been suspended; and
a vehicle inside-outside collaboration device configured to provide, in accordance with determination by the reception determination unit that the reception has been suspended, the subset information from the in-vehicle server to the driving support device.

2. The in-vehicle device according to claim 1, wherein
the function selection unit includes:
a priority table storage device for storing a priority table defining a priority level of the function for each of one or a plurality of types of the traffic environment;
a priority table selection unit configured to identify a traffic environment of the vehicle and select one, out of the priority tables stored in the priority table storage device, that corresponds to the traffic environment;
a resource information acquisition unit configured to acquire current dynamic information of information processing resources possessed by the vehicle; and
a sub-function selection unit configured to select, in accordance with a priority defined by the priority table selected by the priority table selection unit, the sub-function within a range allowed by the information processing resources, based on the dynamic information acquired by the resource information acquisition unit.

3. The in-vehicle device according to claim 2, wherein
the priority table selection unit identifies the traffic environment of the vehicle, based on a dynamic map and a position of the vehicle.

4. The in-vehicle device according to claim 2, wherein
the dynamic information acquired by the resource information acquisition unit is dynamic information of at least a plurality of information processing resources out of the information processing resources possessed by the vehicle, and
the in-vehicle server distributes a function to a plurality of information processing resources in the information processing resources possessed by the vehicle, thereby processing the function.

5. The in-vehicle device according to claim 2, wherein
the sub-function selection unit includes:
a first sub-function selection unit configured to select, in accordance with the priority defined by the priority table selected by the priority table selection unit, the sub-function within the range allowed by the information processing resources, based on the dynamic information acquired by the resource information acquisition unit; and
a second sub-function selection unit configured to select another of the sub-functions necessary for execution of the sub-function selected by the first sub-function selection unit.

6. The in-vehicle device according to claim 2, wherein
the function selection unit further includes a function storage configured to store a function having been executed by the driving support device, in accordance with the determination by the reception determination unit that the reception has been suspended; and
the sub-function selection unit
selects, in accordance with the priority defined by the priority table selected by the priority table selection unit, the sub-function within the range allowed by the information processing resources and from functions stored in the function storage, based on the dynamic information acquired by the resource information acquisition unit.

7. The in-vehicle device according to claim 1, wherein
the in-vehicle server decides, for each function selected by the function selection unit, a cooperation node from which data necessary for realizing the function is to be collected.

8. The in-vehicle device according to claim 1, wherein
the in-vehicle server decides a cooperation node from which data necessary for realizing functions selected by the function selection unit is to be collected, such that the cooperation node is common among all the selected functions.

9. An operation method for an in-vehicle device mounted to a vehicle including a driving support device configured to use information from an external server,
the operation method comprising:
a step of constructing an in-vehicle server capable of executing one or a plurality of sub-functions forming a subset of a function of the external server, the in-vehicle server being configured to use data received from outside and output subset information capable of replacing a part of the information;
a step of selecting, in response to a fact that reception of the information from the external server has been suspended, one of the sub-functions executed by the in-vehicle server, in accordance with a priority based on a traffic environment where the vehicle is in;
a step of determining that the reception of the information from the external server has been suspended; and
a step of providing, in accordance with determination that the reception has been suspended, the subset information from the in-vehicle server to the driving support device.

10. A vehicle having mounted thereto the in-vehicle device according to claim 1.
